(19) United States
(12) Patent Application Publication
(10) Pub. No.: US 2011/0056334 A1
(43) Pub. Date: Mar. 10, 2011

(54) DYNAMOMETRIC TOOL WITH REMOVABLE HEAD

(75) Inventors: Philippe Miletto, Orny (CH); Silver Gross, La Chaux-de-Fonds (CH)

(73) Assignee: HADER SA, La Chaux-de-Fonds (CH)

(21) Appl. No.: 12/921,882

(22) PCT Filed: Mar. 9, 2009
(86) PCT No.: PCT/EP09/52707

§ 371 Date: Nov. 3, 2010

(30) Foreign Application Priority Data
Mar. 11, 2008 (EP) 08152611.3

(51) Int. Cl. B25B 23/16; B23P 11/00

(52) U.S. Cl. 81/58; 81/177.85; 29/428

(57) ABSTRACT

A dynamometric tool having a longitudinal axis and capable of providing a tightening torque, includes: a head with a first housing arranged along the longitudinal axis and a second circular housing arranged along a transverse axis perpendicular to the longitudinal axis, the head being adapted for receiving a dowel in the second housing; a shaft to be received in the first housing, the shaft being capable of assuming a working position in which a first end thereof is located in the second housing for engaging with the dowel. In order to make the tool fully removable, the head and the first end of the shaft are arranged and sized so that the head and the shaft can assume a first relative orientation in which the shaft can slide freely relative to the head so that the head can be removed from the shaft, and a second relative orientation in which bearing members are arranged so as to maintain the shaft in the working position.

### TECHNICAL FIELD

This invention relates to the field of medical equipment and relates to a dynamometric tool of longitudinal axis AA, capable of providing a tightening torque comprising:
a head provided with a first housing arranged along the longitudinal axis and a second circular housing arranged along a transverse axis, perpendicular to the longitudinal axis, the head being designed to receive a dowel in the second housing;
a sleeve designed to be placed in the first housing, the sleeve being adapted to assume a working position wherein a first one of the ends thereof is located in the second housing for engaging with the dowel.

Such a tool is particularly used in surgery as a wrench, usually called sextant wrench, particularly in the dental field for implants.

### STATE OF THE ART

Sextant wrenches are well known by the skilled person in the art and are widely used for the application of tightening torques. Some models are equipped with torque limiters and/or indicators designed to give a numerical value to the user during the tightening step.

Generally, this type of wrench consists of a head where a tightening dowel and a sleeve are housed, the latter working with the dowel during the tightening step. These wrenches may comprise a spring which acts on the sleeve end position when rotating the wrench in the opposite direction of tightening.

The main drawback of the known systems is that, once positioned, the sleeve is not partially, or not at all, removable from the head of the device, thereby making it difficult to clean the set, which is particularly important in the medical field.

Moreover, the tightening dowel must be easily removable and replaceable. However, in the tools of the prior art, it is not blocked satisfactorily according to the transverse axis when the sleeve is engaged in the head and may therefore be induced to drop from the device that is being used.

This invention proposes to provide a dynamometric tool free of the above drawbacks. It is particularly advantageous in an application as a sextant wrench.

### DISCLOSURE OF THE INVENTION

More particularly, the invention relates to a dynamometric tool as mentioned above, wherein the head and the first end of the sleeve are arranged and sized so that the head and the sleeve can assume a first relative orientation wherein the sleeve can slide freely with respect to the head so that the head is removable from the sleeve, and a second relative orientation wherein bearing members are arranged so as to maintain the sleeve in working position.

### BRIEF DESCRIPTION OF THE DRAWINGS

Other characteristics of this invention will become more evident by reading the description which follows with reference to the accompanying drawings, wherein:

FIG. 1 shows a detailed view of the arrangement of the sextant wrench end, once mounted and an additional cross-sectional view along the indicated axis.

FIGS. 2, 3, 4, and 5 show various steps of the assembly of a tool according to the invention, with indexed views, a, in cross-section along longitudinal axis AA, and indexed views, b, in cross-section along the indicated axes.

### EMBODIMENT(S) OF THE INVENTION

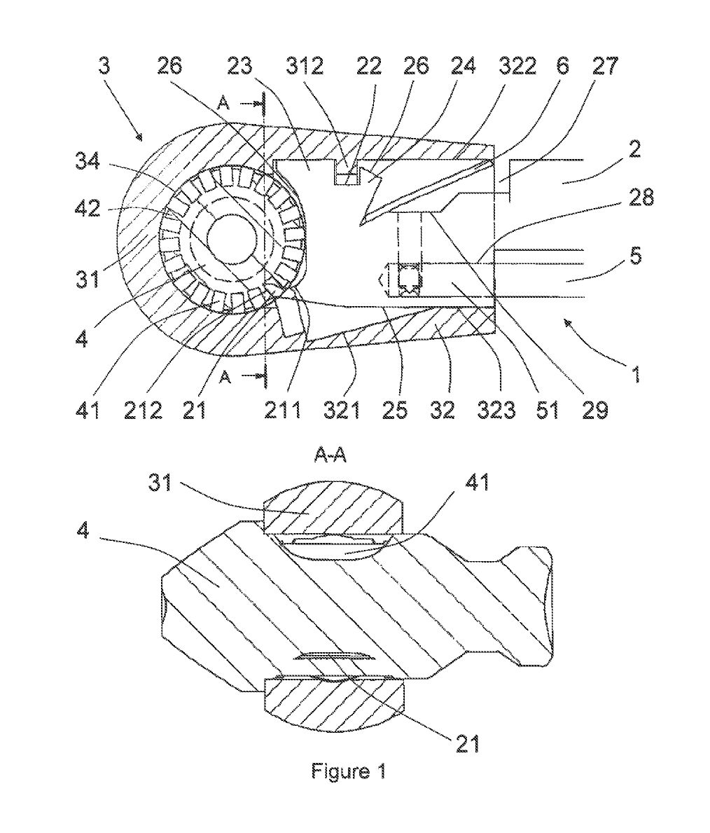

FIG. 1 presents a sextant wrench 1 according to the invention, ready to be used. The wrench defines a longitudinal axis AA and a transverse axis BB, shown in the drawings.

The wrench 1 has a sleeve 2 having a general shape of a stirrer bar. It has a lower surface 25 and an upper surface 29 parallel to axis AA. The sleeve also defines a first end formed with a concave wall 26 the general direction of which is substantially perpendicular to the upper surface 29, completed at its base with a protrusion 21 extending the lower surface 25. The protrusion 21 has a curved sidewall 211 and a substantially straight sidewall 212. The right sidewall 212 is located in the extension of the lower surface 25 of the sleeve 2.

The upper surface 29 of the sleeve 2 has a groove 22 defining a first edge 23 and a second edge 24. The second edge 24 is located on the opposite side of the first end and has an indentation 26 at the end thereof, the role of which will become evident below. The upper surface 29 also has a bowl 27 designed for receiving a spring 6, the utility of which will also be explained further down. The sleeve 2 further has an elongated cavity 28 positioned in its lower part and an axis parallel to the surface 25.

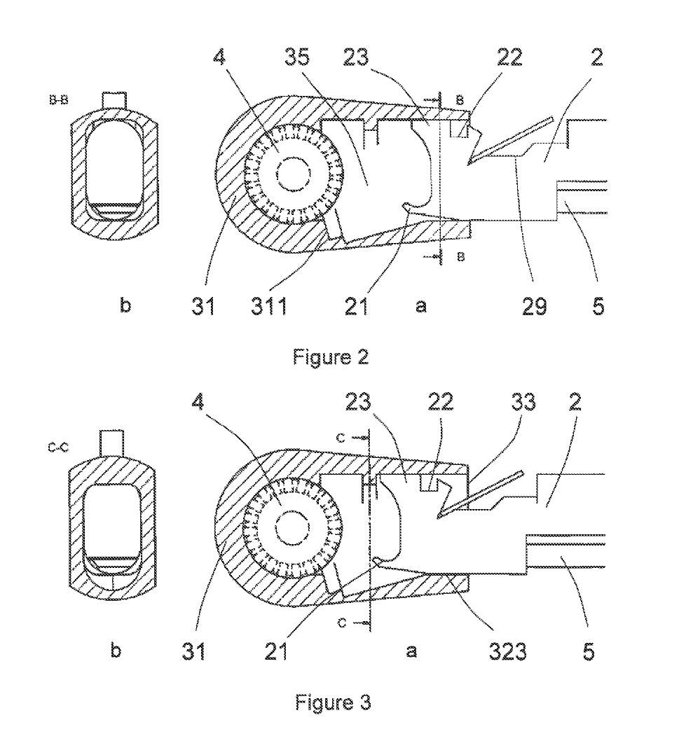

The wrench 1 also comprises a head 3 comprising a semicircular part 31 extended by a part with a trapezoidal 32 shape. The inner head 3, which is formed by a first housing 35 (see FIG. 2), with a longitudinal axis AA, is located at the trapezoidal part 32 of the head 3 and outlets to the outside, thus forming an opening 33 (see FIG. 3). The housing 35 has a lower wall 321, finishing by a substantially perpendicular surface 311 (FIG. 2) the role of which will be explained further down, and an upper wall 322. The upper wall 322 is parallel to longitudinal axis AA. It has a lug 312, typically located at two-thirds of the length thereof from the opening 33. The lower wall 321 of cavity 35 is inclined with respect to longitudinal axis AA in such a way so that the two walls 321 and 322 diverge towards the interior of the cavity 35.

The inner head 3 is also formed by a second housing 34, cylindrical of axis BB, located at the end 31 of the head 3. It is in connection with the first housing 35. Preferably, the housing 34 is concentric with the area 31.

The wrench 1 also has a tightening dowel 4, equipped at its surface with grooves 41 separated among them by the parts 42. It is inserted into the housing 34 of the head 3 and arranged along axis BB. When the dowel is positioned in the housing 34, the grooves are oriented also along axis BB. As shown in cross-section AA of FIG. 1, the grooves 41 have not been machined over the entire height of the dowel 4, but simply on a part not exiting on either of the two ends of the dowel 4. The grooves 41 thus have a length lower than the total height of the tightening dowel 4. The dowel 4 is placed so that one part of the grooves 41 is located opposite to the end of the housing 35.

The first end of the sleeve 2 and the opening 33 are sized so that the head 3 is freely removable from the sleeve 2, while defining a secure working position, wherein the head and sleeve are integral in translation. More particularly, it is planned to introduce the sleeve 2 in the head 3 by arranging these two elements according to a first relative orientation. Thus, the introduction is carried out by placing the lower surface 25 of the sleeve 2 in contact with the lower wall 321 of the housing 35, in a parallel manner to the latter. The height of the end of sleeve 2 between the lower surface 25 thereof and the upper surface of the edge 23 is lower than the height defined by the opposing surfaces 321 and 322, in a perpendicular manner to the surface 321. Thus, when the sleeve is oriented by reference to the head, in a parallel manner to the surface 321, it is possible to make it translate until the protrusion 21 abuts against the surface 311.

The lug 312 and the groove 22 are positioned and sized so that when the protrusion 21 abuts against the surface 311, the edge 23 has passed through the lug 312. In addition, and advantageously, the lug 312 and the groove 22 are arranged so that when the protrusion 21 abuts against the surface 311, the sleeve 2 can be rotated so that the lug 312 engages in the groove 22. The indentation 26 of the edge 24 is particularly shaped in order to allow this rotation, without letting the edge 24 to come into contact against the wall 322 of the head 3. The dimensional ratios between the lug and throat provide blocking of the sleeve 2 in translation along longitudinal axis AA, forwards and backwards. The surface 25 of the said sleeve 2 is in contact with the wall 321 only by a bearing surface 323 at the outlet end of the wall 321. This support surface 323, on the one hand, the lug 312 and the groove 22, on the other hand, form bearing members that allow defining the working position of the sleeve, wherein the protrusion 21 is likely to engage with the grooves 41 of the dowel 4.

Thus, given the structure of the grooves 41 described above, the tightening dowel 4 is blocked in translation along axis BB, while the sleeve 2 is in its working position.

It is understood that, for the disassembly of the sextant wrench 1, it is the reverse operation, which is performed by tilting the sleeve 2 until the surface 25 is parallel to, and in contact with, the inner wall 321 of the cavity 35. It will therefore be sufficient to translate the sleeve 2 along this wall to finish the extraction and completely separate the head and the sleeve.

The spring 6, positioned in the bowl 27, is designed to come into contact with the wall 322 of the housing 35. This spring 6 takes action when the wrench 1 is rotated in the opposite direction of the tightening (anticlockwise) and exerts pressure on the sleeve 2 which allows the return of the protrusion 21, present at the end of the sleeve 2, in the following groove of the tightening dowel 4, once the part 42 separating the two successive grooves is crossed.

The wrench 1 also has a flexible rod 5 of which one of the ends is inserted into the cavity 28 of sleeve 2. The other end of the said flexible rod 5 is free and can evolve opposite to a graduated scale, thus indicating the applied torque. The user can therefore act on the rod 5 when it is desired to exert a controlled torque and will act directly on the sleeve 2 when it is desired to exert two maximum torques.

The rod 5 is secured to the sleeve 2 by means of a pin not shown in the drawing. The lug is arranged in order to maintain in position the flexible rod 5 by engaging with an annular groove contained by the rod 5. This avoids any modification of the mechanical characteristics of the rod 5, since the latter does not undergo either thermal or mechanical stress treatment.

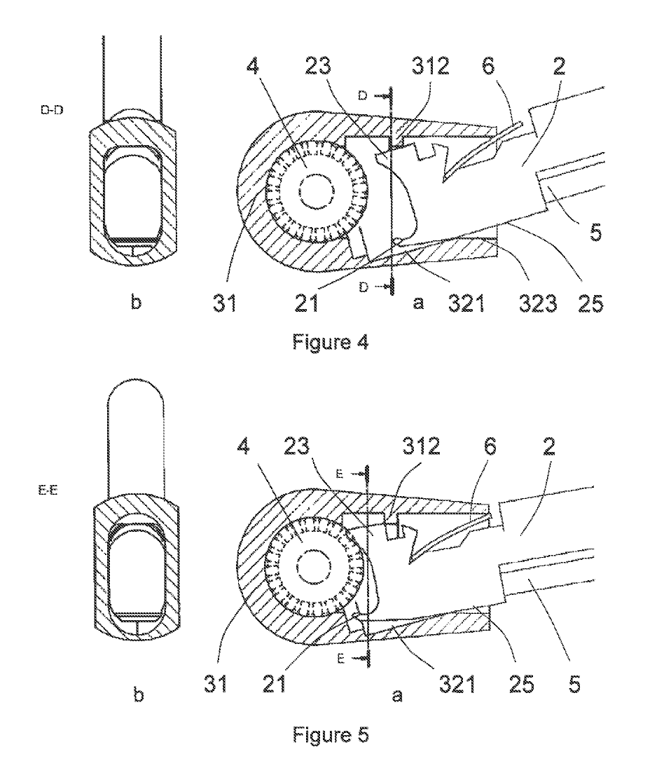

FIGS. 2, 3, 4 and 5 show a method of assembling the sextant wrench 1, with views 2a, 3a, 4a and 5a along longitudinal axis AA and cross-sectional views 2b, 3b, 4b and 5b along the indicated axes. More particularly, they show the method of assembly of the head 3 and the sleeve 2 of the sextant wrench 1 described above. In these figures, the dowel 4 is partially shown in dotted lines because it is normally placed after the step, corresponding in FIG. 5.

Firstly the sleeve 2 and head 3 are arranged in their first relative position. Then the first end of the sleeve 2 is inserted into the first housing 35 through the opening 33 and is translated within the housing 35 by retaining the first relative orientation of the sleeve 2 and of the head 3. When the translation is completed, that is to say, when the first end 21 abuts against the surface 311, the sleeve 2 and the head 3 are arranged in their second relative position, so that the sleeve 2 is placed in its working position. Advantageously, when the sleeve 2 is tilted so that the latter and the head 3 are placed in their second orientation, they are positioned directly to allow the bearing members to maintain the working position. More particularly, when the sleeve is placed in abutment against the surface 311 and then the sleeve and the head are placed in their second relative orientation, the lug 312 is inserted into the groove 22 through these operations.

Subsequently, extraction of the sleeve 2, for maintenance or sterilisation, will be carried out by following the previous steps in the reverse direction.

Thus, a dynamometric tool is obtained, the head of which, is very simply and easily removable from the front, that is to say from the side of the first end of the sleeve, while ensuring maintaining perfectly the working position of the sleeve, with reference to the head and by securing the implementation of the dowel in the tool while it is being used.

Although the above description has been made with reference to a wrench sextant, it may be applied to other dynamometric tools. The above example is not exhaustive or limiting and the skilled person of the art may consider other embodiments within the reach of the latter, without however departing from the scope of this invention.

1-13. (canceled)

14. A dynamometric tool of longitudinal axis AA, capable of supplying a tightening torque, comprising:
a head provided with a first housing arranged along the longitudinal axis AA and a circular second housing arranged along a transverse axis BB, perpendicular to the longitudinal axis AA, said head being designed to receive a dowel in said second housing,
a sleeve designed to be placed in the first housing, said sleeve being able to assume a working position in which a first of its ends is located in said second housing so as to engaging with said dowel,
wherein the head and the first end of the sleeve are arranged and dimensioned in such a way that the head and the sleeve can assume a first relative orientation in which the sleeve can slide freely with respect to the head so that the head is removable from the sleeve on the side of the first end, and a second relative orientation in which bearing members are arranged so as to maintain the sleeve in the working position.

15. The tool of claim 14, wherein the first housing defines a first wall and a second wall, the first wall being parallel to said longitudinal axis AA and the second wall being essentially oriented along the longitudinal axis AA without being parallel thereto,
and wherein the height between the walls with reference to the second wall is greater than the height of said first end of said sleeve.

16. The tool of claim 14, wherein the housing comprises a stop member arranged so as to define an end position of the sleeve with reference to the head, when the sleeve and the head are in their first relative orientation.

17. The tool of claim 15, wherein the housing comprises a stop member arranged so as to define an end position of the sleeve with reference to the head, when the sleeve and the head are in their first relative orientation.

18. The tool of claim 15, wherein the bearing members comprise a lug located on the first wall and a notch provided on the sleeve and defined by a first edge and a second edge, the lug and the notch being arranged so that the lug is positioned in the notch when the sleeve is in the working position.

19. The tool of claim 16, wherein the bearing members comprise a lug located on the first wall and a notch provided on the sleeve and defined by a first edge and a second edge, the lug and the notch being arranged so that the lug is positioned in the notch when the sleeve is in the working position.

20. The tool of claim 17, wherein the bearing members comprise a lug located on the first wall and a notch provided on the sleeve and defined by a first edge and a second edge, the lug and the notch being arranged so that the lug is positioned in the notch when the sleeve is in the working position.

21. The tool according to claim 14, wherein the stop member, the notch and the lug are arranged so that, when the sleeve is in said end position, the passage of the sleeve and of the head from their first to their second relative orientation allows the lug to engage in the notch.

22. The tool according to claim 18, wherein the bearing members additionally comprise the end of the second wall.

23. The tool according to claim 21, wherein the bearing members additionally comprise the end of the second wall.

24. The tool according to claim 14, comprising additionally a flexible rod, one of the ends of which is secured to the sleeve.

25. The tool according to claim 21, comprising additionally a flexible rod, one of the ends of which is secured to the sleeve.

26. The tool according to claim 24, wherein said rod is mounted idle in an opening on the sleeve, a locking element securing the sleeve and the rod.

27. The tool according to claim 25, wherein said rod is mounted idle in an opening on the sleeve, a locking element securing the sleeve and the rod.

28. The tool of claim 26, wherein the locking element is a pin, the rod comprising an annular groove with which the pin cooperates.

29. The tool of claim 27, wherein the locking element is a pin, the rod comprising an annular groove with which the pin cooperates.

30. The tool according to claim 14, comprising a dowel arranged in the second housing, said dowel being provided with grooves on its surface, the end of the sleeve being provided with a protrusion which is designed to engage in a groove of the dowel so as to drive said dowel in rotation, wherein the ends of the grooves of the tightening dowel are not open along the transverse axis, the protrusion of the sleeve being able to lock the dowel in terms of vertical translation.

31. A method for assembling a head and a sleeve of a dynamometric tool according to claim 14, comprising the following steps:
arranging the sleeve and the head in their first relative orientation,
introducing the first end of the sleeve into said first housing and moving the sleeve in translation inside said first housing, while preserving the first relative orientation of the sleeve and of the head,
arranging the sleeve and the head in their second relative orientation so as to place the sleeve in its working position, and said working position being maintained by the bearing members.

32. A method for assembling a head and a sleeve of a dynamometric tool according to claim 16, comprising the following steps:
arranging the sleeve and the head in their first relative orientation,
introducing the first end of the sleeve into said first housing and moving the sleeve in translation inside said first housing, while preserving the first relative orientation of the sleeve and of the head, wherein the introduction step takes place until the sleeve is in abutment against the stop member of the head, and
arranging the sleeve and the head in their second relative orientation so as to place the sleeve in its working position, and said working position being maintained by the bearing members.

33. A method for assembling a head and a sleeve of a dynamometric tool according to claim 17, comprising the following steps:
arranging the sleeve and the head in their first relative orientation,
introducing the first end of the sleeve into said first housing and moving the sleeve in translation inside said first housing, while preserving the first relative orientation of the sleeve and of the head, wherein the introduction step takes place until the sleeve is in abutment against the stop member of the head, and
arranging the sleeve and the head in their second relative orientation so as to place the sleeve in its working position, and said working position being maintained by the bearing members, wherein, when the sleeve and the head are arranged in their second orientation, the working position is directly maintained by the cooperation of the lug and the notch.
